(19) United States
(12) Patent Application Publication
(10) Pub. No.: US 2026/0226851 A1
(43) Pub. Date: Aug. 6, 2026

(54) INNER SHROUD SECTOR FOR AN AIRCRAFT TURBOMACHINE

(71) Applicant: SAFRAN AIRCRAFT ENGINES, PARIS (FR)

(72) Inventors: Philippe Didier Edmond Andre Liberal NABIAS, MOISSY-CRAMAYEL (FR); Florian Benjamin Kevin LACROIX, MOISSY-CRAMAYEL (FR); Julien VITRA, MOISSY-CRAMAYEL (FR); Arnaud POUPARD, MOISSY-CRAMAYEL (FR); Richard MATHON, MOISSY-CRAMAYEL (FR)

(73) Assignee: SAFRAN AIRCRAFT ENGINES, PARIS (FR)

(21) Appl. No.: 19/150,376

(22) PCT Filed: Jan. 22, 2024
(86) PCT No.: PCT/EP2024/051389

§ 371 Date: Jul. 23, 2025

(30) Foreign Application Priority Data
Jan. 25, 2023 (FR) FR2300666

(51) Int. Cl. F01D 25/24; B64D 27/10; F01D 25/00

(52) U.S. Cl. CPC F01D 25/24; B64D 27/10; F01D 25/005; F05D 2220/323; F05D 2300/603

(57) ABSTRACT

The invention relates to an inner shroud sector (1) configured to internally delimit a secondary duct (41) of an aircraft turbomachine (50), the inner shroud sector (1) comprising a downstream end (2) which comprises an upstream longitudinal portion (3) and a downstream longitudinal portion (4) which are connected by a middle portion (5) and are configured to extend, respectively, in an upstream extension and internally to a nacelle inner casing (31), the inner shroud sector (1) comprising an inner layer and an outer layer of composite material, the middle portion (5) of the downstream end (2) comprising at last one volume of intumescent material sandwiched between the inner layer and the outer layer of the composite material so as to form a local thickened portion in the longitudinal direction.

### TECHNICAL FIELD

The present invention relates to the field of the aircraft turbomachine casings and more specifically to an inner shroud sector.

### BACKGROUND

In known manner, with reference to FIG. 1, an aircraft turbomachine 500, of longitudinal axis X, comprises from upstream to downstream a fan 200, a low-pressure compressor 220, a high-pressure compressor 230, a combustion chamber 240, a high-pressure turbine 250 and a low-pressure turbine 260. The compressors 220, 230, the combustion chamber 240 and the turbines 250, 260 together define a primary flow path 400 for an air flow, delimited externally by a central casing 270. The aircraft turbomachine 500 also comprises a secondary flow path 410 for circulating an air flow, which extends externally around the primary flow path 400 and is surrounded by a nacelle 300.

In a known manner and as illustrated in FIG. 1, the aircraft turbomachine 500 comprises an intermediate casing 190 comprising an inner shroud 100 and an outer shroud 180 which respectively delimit the interior and exterior of the secondary flow path 410. The inner shroud 100 is attached upstream to a hub 160 of the intermediate casing 190. The inner shroud 100 and the outer shroud 180 are connected by arms 170 extending radially into the secondary flow path 410 downstream of a row of outlet guide vanes (OGV) 330. The outer shroud 180 extends downstream extension of the fan casing 210 and in the upstream extension of an outer fan duct 320.

In a known manner and as illustrated in FIGS. 1 and 2, the inner shroud 100 extends in the upstream extension of an inner fan duct 310, which delimits with the central casing 270 a compartment core 280 extending radially between the primary flow path 400 and the secondary flow path 410. More specifically, with reference to FIG. 2, the inner shroud 100 comprises a step-shaped downstream end 120 configured to be straddled by an upstream end of the inner fan duct 310 and secured thereto by attachment screws inserted radially into housings 130. This type of assembly is known as swage.

In practice, the inner shroud 100 is formed by several angular inner shroud sectors 110, connected together by joining plates 140 by means of attachment screws inserted radially into housings 130. The inner shroud sectors 110 are typically in the form of one-piece titanium parts. Advantageously, titanium has a high mechanical strength and a thermal resistance to deformation, but also a high density, which leads to high mass inner shroud sectors 110. This has the effect of making the aircraft turbomachine 500 heavier and therefore increasing its energy consumption in flight.

In order to reduce the mass of an inner shroud sector, inner shroud sectors of variable titanium thickness are known, the thickness of which is reduced in the areas subject to little stress and greater in the areas subject to the greatest stress, for example in the attachment housings. However, this gain in mass is not enough.

It is known from patent application US2021340881 A1 that a fan casing externally delimiting the air flow path is formed from a composite material with a honeycomb stiffening element.

The invention thus aims to reduce the mass of an inner shroud sector for an aircraft turbomachine while maintaining satisfactory mechanical and thermal resistance to deformation.

### SUMMARY

The invention relates to an inner shroud sector configured to be mounted in an aircraft turbomachine, the inner shroud being a revolving part defined with respect to a longitudinal axis oriented from upstream to downstream configured to internally delimit a secondary flow path of the aircraft turbomachine, the inner shroud sector comprising a downstream end comprising:
an upstream longitudinal portion located at a first radial distance from the longitudinal axis and configured to extend in the upstream extension of an inner fan duct,
a downstream longitudinal portion located at a second radial distance from the longitudinal axis less than the first radial distance and configured to extend inwardly of the inner fan duct, and
a middle portion connecting the upstream longitudinal portion and the downstream longitudinal portion.

The invention is remarkable in that the inner shroud sector comprises at least one inner layer of composite material and at least one outer layer of composite material, the composite material being in the form of a plurality of reinforcing fibers in a matrix, the middle portion of the downstream end comprising at least one volume of intumescent material sandwiched between the inner layer of composite material and the outer layer of composite material so as to form a local extra thickness in the longitudinal direction.

The use of composite material advantageously allows to reduce the mass of the inner shroud sector. The intumescent material reduces the level of porosity in the composite material in the middle portion, resulting in an inner shroud sector with very good mechanical strength. The layers of composite material, which are initially malleable, need to be hardened together by radial compression at a heating temperature. However, radial compression does not effectively compress the middle portion, particularly when it extends radially over a distance greater than two thicknesses of longitudinal portion. The volume of intumescent material thus allows, thanks to its expansion properties under the effect of heat, to further compress the composite material in the middle portion to locally reduce the porosity. The intumescent material also makes it easier and quicker to form an extra thickness than using pre-cut layers of composite material. Such an arrangement with an intumescent film allows local variations in thickness at the level of the downstream end of the composite sector, which allows to obtain an internal recess profile that differs from the external step-off profile: typically, an angular (steep) external profile and a regular, gradual internal profile that is well suited to sealing with a gasket.

According to a preferred aspect of the invention, the inner shroud sector comprises a plurality of layers of composite material, each extending uniformly throughout the downstream end. The use of intumescent material avoids the time-consuming task of cutting out and locally superimposing layers of composite material to define the extra thickness.

According to one aspect of the invention, the volume of intumescent material of the middle portion has a longitudinal thickness in a direction parallel to the longitudinal axis which decreases radially from the outside inwards, preferably from a maximum value to a minimum value at least twice as small. Preferably, the maximum value of the longitudinal thickness is at least four times greater than the minimum value. Preferably, the maximum value of the longitudinal thickness is at most ten times greater than the minimum value. The intumescent material is advantageously located in the middle portion so as to increase the longitudinal component of the middle portion and reduce its radial component. The middle portion thus forms a gentler radial slope, allowing better compression of the composite material.

According to one aspect of the invention, the middle portion comprises an outer wall transverse to the longitudinal axis. This ensures an abutment and the cooperation with the upstream end of the inner fan duct.

According to one aspect of the invention, the middle portion comprises at least a first angular slice and a second angular slice juxtaposed, the volume of intumescent material extending only in the first angular slice. This forms a longitudinal attachment strip, preferably at the angular rim of the inner shroud sector, to ensure that it is attached to an adjacent inner shroud sector.

According to one aspect of the invention, the middle portion comprises an inner surface forming, at the level of the first angular slice, a longitudinal protuberance with respect to the second angular slice. This longitudinal protuberance increases the longitudinal component of the middle portion and reduces its radial component. The middle portion thus has a gentler radial slope, allowing better compression of the composite material. Advantageously, no protuberance is formed on the outer surface side to allow the cooperation with the inner fan duct.

According to one aspect of the invention, the volume of intumescent material extends radially throughout the middle portion, so as to connect the upstream longitudinal portion and the downstream longitudinal portion and form a gentle radial slope ensuring a good radial compression.

In one aspect of the invention, the middle portion comprises at least one separating film separating the volume of intumescent material from the inner layer of composite material and the outer layer of composite material. Preferably, the separating film is watertight. This prevents material deformation during compression and heating, thereby improving the mechanical strength of the final part.

According to one aspect of the invention, the middle portion extends radially over a distance at least twice as great as a radial thickness of the upstream longitudinal portion, preferably at least four times as great. According to a preferred aspect, the middle portion extends radially over a distance greater than a radial thickness of the downstream longitudinal portion, preferably at least three times greater. Such a middle portion makes it all the more necessary to use intumescent material to reinforce the compression.

According to one aspect of the invention, the inner layer of composite material and the outer layer of composite material comprise, at the level of the middle portion, a porosity of less than 2%, preferably less than 1% and preferably less than 0.7%. This level of porosity ensures a good mechanical strength.

According to one aspect of the invention, the volume of intumescent material of the middle portion is designated a first volume of intumescent material, the downstream longitudinal portion comprising at least one second volume of intumescent material sandwiched between the inner layer of composite material and the outer layer of composite material so as to form a local extra thickness in the radial direction, the second volume of intumescent material extending in the longitudinal extension of the first volume of intumescent material. The first and second volumes of intumescent material together form a longitudinal attachment strip of high mechanical strength.

According to a preferred aspect, the upstream longitudinal portion comprises at least one third volume of intumescent material sandwiched between the inner layer of composite material and the outer layer of composite material so as to form a local extra thickness in the radial direction, the third volume of intumescent material extending in the longitudinal extension of the first volume of intumescent material. The first and third volumes of intumescent material together form a longitudinal attachment strip of high mechanical strength.

The invention relates to an inner shroud sector as previously described prior to compression and heating, wherein the intumescent material is adapted to expand under the effect of heat, preferably at a predetermined temperature greater than 115° C., the predetermined temperature preferably being less than 180° C. Before compression and heating, the composite material and the intumescent material are in a malleable state.

The invention also relates to an inner shroud sector as described above after compression and heating, wherein the intumescent material is in an expanded state. After compression and heating, the composite material and the intumescent material are in a hardened state.

The invention also relates to an inner shroud for an aircraft turbomachine comprising a plurality of inner shroud sectors as described above, the inner shroud being a revolving part defined with respect to a longitudinal axis oriented from upstream to downstream configured to internally delimit a secondary flow path of the aircraft turbomachine.

The invention also relates to an intermediate casing for an aircraft turbomachine comprising an inner shroud as described above, the intermediate casing comprising a hub, to which the inner shroud is attached, and an outer shroud, which extends opposite the inner shroud and is configured to externally delimit a secondary flow path of the aircraft turbomachine. The intermediate casing preferably comprises at least one arm connecting the inner shroud and the outer shroud.

The invention also relates to an aircraft turbomachine comprising a primary flow path and a secondary flow path extending externally around the primary flow path, the aircraft turbomachine comprising an intermediate casing as described above wherein the inner shroud and the outer shroud delimit the secondary flow path internally and externally respectively. Preferably, the outer shroud extends in the downstream extension of a fan casing.

### BRIEF DESCRIPTION OF THE DRAWINGS

The invention will be better understood on reading the following description, given by way of example, with reference to the following figures, given by way of non-limiting examples, wherein identical references are given to similar objects.

FIG. 1 is a schematic representation in longitudinal half-section of an aircraft turbomachine according to the prior art.

FIG. 2 is a schematic representation in perspective from downstream of an inner shroud sector according to the prior art.

FIG. 3 is a schematic representation in longitudinal half-section of an aircraft turbomachine comprising inner shroud sectors according to one embodiment of the invention.

FIG. 4 is a schematic perspective representation from downstream of an inner shroud sector according to one embodiment of the invention.

FIG. 5 is a schematic perspective view from downstream of the downstream end of the inner shroud sector of FIG. 4,

FIG. 6 is a schematic representation in radial cross-section of the first angular slice of the downstream end of FIG. 5.

FIG. 7 is a schematic representation in perspective from upstream of the downstream end of FIG. 5.

FIG. 8 is a schematic representation in radial cross-section of the first angular slice of the downstream end according to another embodiment comprising a separating film.

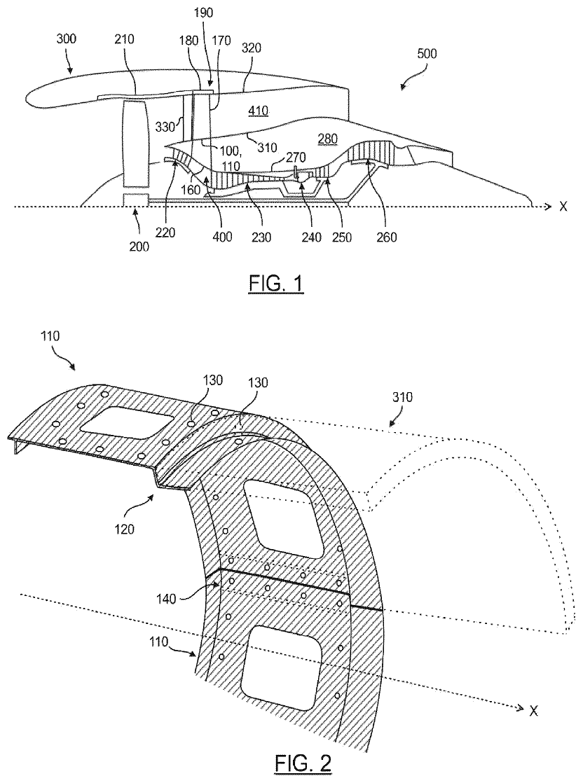

It should be noted that the figures set out the invention in detail in order to implement the invention, said figures of course being able to be used to better define the invention if necessary.

### DETAILED DESCRIPTION

With reference to FIG. 3 and as described in the preamble, an aircraft turbomachine 50 classically extends along a longitudinal axis X oriented from upstream to downstream. Hereafter, the terms “upstream” and “downstream” are defined in relation to the orientation of the longitudinal axis X. The terms “inner” and “outer” are defined in relation to a radial axis extending orthogonally to the longitudinal axis X.

Still with reference to FIG. 3, the aircraft turbomachine 50 typically comprises, from upstream to downstream, a fan 20, a low-pressure compressor 22, a high-pressure compressor 23, a combustion chamber 24, a high-pressure turbine 25 and a low-pressure turbine 26. The compressors 22, 23, the combustion chamber 24 and the turbines 25, 26 together define a primary flow path 40 for an air flow, delimited externally by a central casing 27. The aircraft turbomachine 50 also comprises a secondary flow path 41 for circulating an air flow which extends externally around the primary flow path 40 and is surrounded by a nacelle 30.

With reference to FIG. 3, the aircraft turbomachine 50 comprises an intermediate casing 19 comprising an inner shroud 15 and an outer shroud 18 which respectively delimit internally and externally the secondary flow path 41. The inner shroud 15 is attached upstream to a hub 16 of the intermediate casing 19. The inner shroud 15 and the outer shroud 18 are connected in this example by arms 17 extending radially into the secondary flow path 41, downstream of a row of outlet guide vanes (OGV) 33. The outer shroud 18 extends in the downstream extension of the fan casing 21 and in the upstream extension of an outer fan duct 32. The inner shroud 15 extends in the upstream extension of an inner fan duct 31, which together with the central casing 27 defines a compartment core 28 extending radially between the primary flow path 40 and the secondary flow path 41.

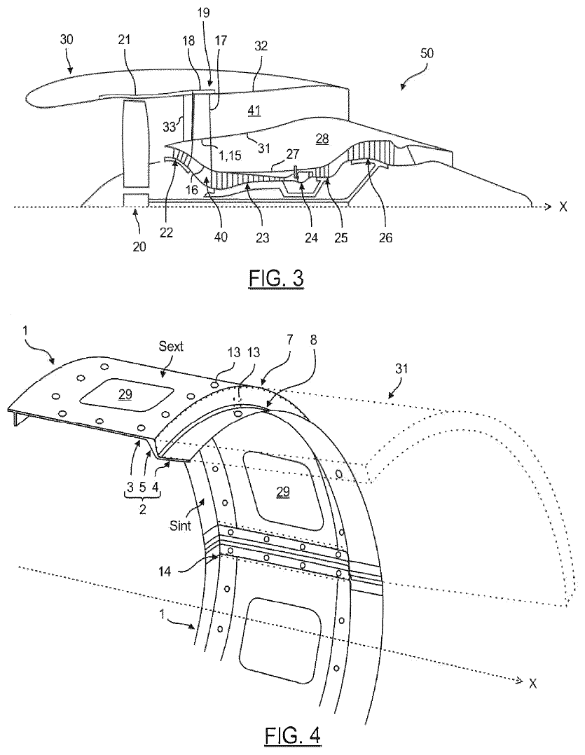

As illustrated in FIGS. 3 and 4, the inner shroud 15 is a revolving part defined with respect to the longitudinal axis X in the aircraft turbomachine 50, the longitudinal axis X hereinafter designating indifferently the axis of the turbomachine 50 and the axis of the inner shroud 15, which are coincident. The inner shroud 15 is formed by an assembly of inner shroud sectors 1 connected together and distributed angularly around the longitudinal axis X. The inner shroud sectors 1 preferably extend over a variable angular width.

According to the invention and as illustrated in FIG. 4, each inner shroud sector 1 comprises a downstream end 2 comprising a longitudinal upstream portion 3 and a longitudinal downstream portion 4 connected by a middle portion 5. The upstream longitudinal portion 3 and the longitudinal portion 4 are located respectively at a first radial distance R3 and at a second radial distance R4 from the longitudinal axis X satisfying: R4>R3 (FIG. 6). The upstream longitudinal portion 3 extends in the upstream extension of the inner fan duct 31. The downstream longitudinal portion 4 extends inside the inner fan duct 31. Preferably, the middle portion 5 extends radially over a distance H of between 24 mm and 32 mm.

According to the invention and as illustrated in FIGS. 4 and 6, the inner shroud sector 1 comprises at least one inner layer of composite material 9a and at least one outer layer of composite material 9b, the composite material being in the form of a plurality of reinforcing fibers in a matrix, the middle portion 5 of the downstream end 2 comprising at least one volume of intumescent material 10-1 sandwiched between the inner layer of composite material 9a and the outer layer of composite material 9b so as to form a local extra thickness in the longitudinal direction. Preferably, each layer of composite material 9a, 9b has a constant thickness.

Advantageously, the composite material has a reduced density compared with the titanium traditionally used, which allows to obtain an inner shroud sector 1 of reduced mass. The choice of composite material, usually preferred for aircraft parts of uniform thickness and less exposed to mechanical stress and thermal deformation, is unprecedented in an inner shroud sector 1.

The intumescent material is used to improve the material strength of the inner shroud sector 1, i.e. to ensure a low level of porosity in the composite material. As will be seen later, the inner shroud sector 1 is formed by heating and compressing an assembly of layers of composite material, with one or more volumes of intumescent material interposed. The compression takes place between two molds along the stacking axis of the layers of composite material, i.e. radially, which does not ensure sufficient compression in the middle portion 5. Thanks to its expansion properties when heated, the intumescent material helps to compress the composite material in the middle portion 5, to obtain the desired level of porosity.

The volume of intumescent material also advantageously comprises any size and shape, making it easy to obtain the desired extra thickness. This avoids the need to form the extra thickness using layers of composite material, each cut to precise dimensions, as such layers are also likely to move during heating and compression.

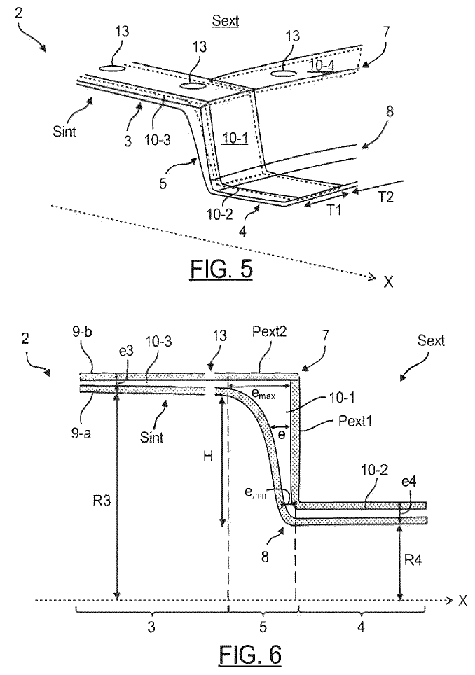

According to a preferred aspect illustrated in FIGS. 5 to 7, the inner shroud sector 1 comprises several volumes of intumescent materials 10-1, 10-2, 10-3, 10-4. In this example, the inner shroud sector 1 comprises:
the volume of intumescent material 10-1 located in the middle portion 5 and hereinafter referred to as the “first volume of intumescent material 10-1”,
a second volume of intumescent material 10-2 located in the downstream longitudinal portion 4 in the downstream extension of the first volume of intumescent material 10-1, and
a third volume of intumescent material 10-3 located in the upstream longitudinal portion 3 in the upstream extension of the first volume of intumescent material 10-1.

The first volume of intumescent material 10-1 is continuous with the second volume of intumescent material 10-2 and the third volume of intumescent material 10-3 so as together to form a thickened longitudinal strip extending in a first angular slice T1 of the inner shroud sector 1, preferably located at an angular edge of the inner shroud sector 1. Such a thickened longitudinal strip allows the inner shroud sector 1 to be attached to an adjacent inner shroud sector 1 or to an arm 17, preferably via a joining plate 14 (FIG. 4). To this end, the thickened longitudinal strip comprises one or more attachment housings 13 into which attachment elements, such as screws, nails or rivets, are radially inserted. Preferably, the inner shroud sector 1 comprises such a thickened longitudinal strip at its two angular edges.

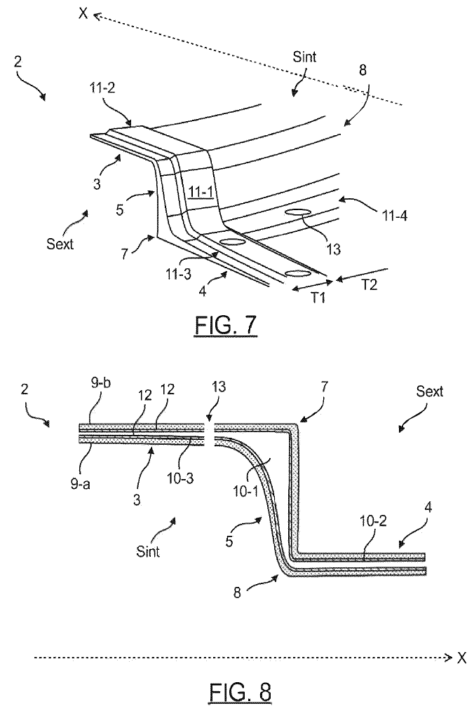

Also according to a preferred aspect illustrated in FIG. 4, the inner shroud sector 1 comprises one or more apertures 29 connected to a discharge pipe for an air flow taken upstream of the low-pressure compressor 22, to avoid the occurrence of a low-flow rate pumping phenomenon. As illustrated in FIGS. 5 and 7, the inner shroud sector 1 preferably comprises a fourth volume of intumescent material 10-4 forming a thickened transverse strip located upstream and downstream of the apertures 29 to allow the discharge pipes to be attached.

With reference to FIG. 6, the inner shroud sector 1 comprises an assembly of radially stacked layers of composite material 9a, 9b, which preferably extend over the entire surface of the downstream end 2 and preferably of the inner shroud sector 1. In this example, only two layers 9a, 9b are shown, but in practice the number of layers is greater than eight. Each layer of composite material 9a, 9b preferably comprises a uniform thickness over its entire surface. The layers 9a, 9b comprise preferably an identical thickness. The composite material is in the form of an assembly of reinforcing fibers, preferably carbon, embedded in a matrix, preferably a polyepoxide, known as “epoxy”. The layers of composite material 9a, 9b are superimposed and have a malleable structure configured to harden and be secured together after heating and pressurization to obtain the final shape of the inner shroud sector 1.

Still referring to FIG. 6, the first volume of intumescent material 10-1 is interposed between an inner layer 9a and an outer layer 9b of composite material. Preferably, the first volume of intumescent material 10-1 is central, i.e. the inner shroud sector 1 comprises substantially the same number of layers on either side of the first volume of intumescent material 10-1. Also preferably, all the volumes of intumescent material 10-1, 10-2, 10-3, 10-4 are interposed between the inner layer 9a and the outer layer 9b. The intumescent volume is initially malleable and configured to expand under the effect of heat, preferably at a predetermined temperature above 115° C., the predetermined temperature preferably being below 180° C. Once heated, the intumescent material remains in a hardened expanded state. The intumescent material preferably comprises polyepoxide, for example in the form of a metal-free epoxy adhesive foam such as FM410-1 or an epoxy adhesive film such as AF3074 FST.

According to a preferred aspect illustrated in FIG. 8, the inner shroud sector 1 further comprises a separating film 12, preferably sealed, extending on either side of the volume of intumescent material 10-1 to separate it from the layers of composite material 9a, 9b. The separating film 12 prevents the intumescent material and the composite material from mixing at the interface during curing and compression. The separating film 12 preferably comprises a composite material, preferably arranged in one or two layers. This ensures a better compression of the composite material and helps to reduce the level of porosity in the composite material.

Preferably, the inner shroud sector 1 consists solely of composite material, intumescent material and preferably separating film 12. It is also preferable for the inner shroud sector 1 to comprise a single-piece structure, for an improved mechanical strength. Again preferably, the level of porosity of the composite material in the inner shroud sector 1 after curing and compression is less than 2%, preferably less than 1% and more preferably less than 0.7%.

As illustrated in FIGS. 5 to 7 and described above, the downstream end 2 comprises a longitudinal upstream portion 3 and a longitudinal downstream portion 4 connected by a middle portion 5, together forming a recess. The middle portion 5 comprises two successive curvatures, namely a first fold 7 and a second fold 8 radially inside the first bend 7. In practice, the downstream end 2 forms a step configured so as to be straddled by an upstream end of the inner fan duct 31 and attached by swage to the latter by means of attachment elements like screws, nails or rivets inserted radially into housings 13 (FIG. 4).

With reference to FIG. 6, the upstream longitudinal portion 3 has a radial thickness e3 which is preferably constant over its entire length. Similarly, the downstream longitudinal portion 4 has a radial thickness e4 that is preferably constant over its entire length, and preferably equal to the thickness e3 of the upstream longitudinal portion 3. The middle portion 5 extends radially over a distance H satisfying H=R4−R3, which is preferably at least twice as great as the thickness e3 of the upstream longitudinal portion 3, preferably at least four times as great, and even more preferably at most ten times as great.

With reference to FIGS. 5 and 6, the middle portion 5 comprises a transverse outer wall Pext1, defined between the first fold 7 and the second fold 8, and a longitudinal outer wall Pext2 defined upstream of the first fold 7 and extending in the extension of the upstream longitudinal portion 3. The first fold 7 is preferably angled at the level of the outer surface Sext, in this example forming a right angle. Similarly, the second fold 8 is preferably angled at the level of the outer surface Sext, in this example forming a right angle. The transverse outer wall Pext1 extends in a plane transverse to the longitudinal axis X so as to form an abutment for the inner fan duct 31.

With reference to FIGS. 5 to 7, the volume of intumescent material 10-1 has a longitudinal thickness e in a direction parallel to the longitudinal axis X which decreases radially from the outside inwards. The longitudinal thickness e comprises a maximum value eₘₐₓ, defined at the first radial distance R3, and a minimum value eₘᵢₙ, defined at the second radial distance R4, the minimum value eₘᵢₙ being at least two times less than the maximum value eₘₐₓ, preferably at least another time greater and at most ten times greater.

With reference to FIGS. 6 and 7, the first volume of intumescent material 10-1 extends only into a first angular slice T1 of the inner shroud sector 1, the inner surface Sint of which forms a longitudinal protuberance 11-1 with respect to an adjacent second angular slice T2. In other words, the first volume of intumescent material 10-1 forms an extra thickness that is only visible from the inner surface Sint. Advantageously, the outer surface Sext has no protuberance at the level of the first angular slice T1. According to a preferred aspect, the first fold 7 and the second fold 8 are preferably progressively curved at the level of the inner surface Sint. According to a preferred aspect illustrated in FIG. 7, the second, third and fourth volumes of intumescent material 10-2, 10-3, 10-4 form a radial protuberance 11-2, 11-3, 11-4 on the inner surface Sint only.

1-11. (canceled)

12. An inner shroud sector configured to be mounted in an aircraft turbomachine, the inner shroud being a revolving part defined with respect to a longitudinal axis oriented from upstream to downstream configured to internally delimit a secondary flow path of the aircraft turbomachine, the inner shroud sector comprising a downstream end comprising:
an upstream longitudinal portion located at a first radial distance from the longitudinal axis and configured to extend in the upstream extension of an inner fan duct,
a downstream longitudinal portion located at a second radial distance from the longitudinal axis less than the first radial distance and configured to extend inwardly of the inner fan duct, and
a middle portion connecting the upstream longitudinal portion and the downstream longitudinal portion,
the inner shroud sector comprising at least one inner layer of composite material and at least one outer layer of composite material, the composite material being in the form of a plurality of reinforcing fibers in a matrix, the middle portion of the downstream end comprising at least one volume of intumescent material sandwiched between the at least one inner layer of composite material and the at least one outer layer of composite material so as to form a local extra thickness in the longitudinal direction, the at least one layers of composite material and the at least one volume of intumescent material being malleable and adapted to harden during a heating and compression step, the at least one volume of intumescent material being adapted to expand during the heating and compression step.

13. The inner shroud sector according to claim 12, wherein the at least one volume of intumescent material of the middle portion has a longitudinal thickness in a direction parallel to the longitudinal axis which decreases radially from the outside inwards.

14. The inner shroud sector according to claim 12, wherein the middle portion comprises an outer wall transverse to the longitudinal axis.

15. The inner shroud sector according to claim 12, wherein the middle portion comprises at least a first angular slice and a second angular slice juxtaposed, the at least one volume of intumescent material extending only in the first angular slice.

16. The inner shroud sector according to claim 15, wherein the middle portion comprises an inner surface forming, at the level of the first angular slice, a longitudinal protuberance with respect to the second angular slice.

17. The inner shroud sector according to claim 12, wherein the at least one volume of intumescent material extends radially throughout the middle portion.

18. The inner shroud sector according to claim 12, wherein the middle portion comprises at least one separating film separating the at least one volume of intumescent material from the at least one inner layer of composite material and the at least one outer layer of composite material.

19. The inner shroud sector according to claim 12, wherein the middle portion extends radially over a distance at least twice as great as a radial thickness of the upstream longitudinal portion.

20. The inner shroud sector according to claim 12, wherein the at least one inner layer of composite material and the at least one outer layer of composite material comprise, at the level of the middle portion, a porosity of less than 2%.

21. The inner shroud sector according to claim 12, wherein the at least one volume of intumescent material of the middle portion is designated a first volume of intumescent material, the downstream longitudinal portion comprising at least one second volume of intumescent material sandwiched between the at least one inner layer of composite material and the at least one outer layer of composite material so as to form a local extra thickness in the radial direction, the at least one second volume of intumescent material extending in the longitudinal extension of the at least one first volume of intumescent material.

22. An inner shroud sector obtained by heating and compressing the inner shroud sector according to claim 12, wherein the at least one composite material layers and the at least one volume of intumescent material are cured, the at least one volume of intumescent material being in an expanded state.

23. The inner shroud sector according to claim 12, wherein the volume of intumescent material of the middle portion has a longitudinal thickness in a direction parallel to the longitudinal axis which decreases radially from the outside inwards from a maximum value (eₘₐₓ) to a minimum value (eₘᵢₙ) at least twice as small.
